(19) United States
(12) Patent Application Publication
(10) Pub. No.: US 2002/0055852 A1
(43) Pub. Date: May 9, 2002

(54) Provider locating system and method

(76) Inventors: Erik R. Little, Seattle, WA (US); Ashwini Narayanan, Mercer Island, WA (US); Naveen K. Jain, Medina, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 09/953,068

(22) Filed: Sep. 13, 2001

Related U.S. Application Data
(60) Provisional application No. 60/232,457, filed on Sep. 13, 2000.

(51) Int. Cl. G06F 17/60

(52) U.S. Cl. 705/1

(57) ABSTRACT

In accordance with this invention, a system and method of presenting and selecting information on providers of goods or services via a voice interactive device based upon a consumer's location are provided. A wireless indication of a consumer's location passed to such a system along with a detailed provider request. The system is then able to locate nearby providers that match said detailed provider request. Next, the nearby providers are prioritized according to a predetermined criteria, such as by distance, travel time, sponsorship or other possible criteria. The prioritized listing of nearby providers is then sent to the consumer. The consumer may then select a provider, whereupon the system, would return detailed information on the provider to the consumer. Additionally, the system may also respond with directions from the consumer's location to the selected provider.

### CROSS-REFERENCE TO RELATED APPLICATION

This application claims the benefit of U.S. Provisional Application No. 60/232,457, filed Sep. 13, 2000, the benefit of which is hereby claimed under 35 U.S.C. §119. The entire disclosure of the prior application is considered as being part of the disclosure of this application and is hereby incorporated by reference herein.

### FIELD OF THE INVENTION

The present invention relates to locating goods or services for a consumer, and in particular to locating providers of goods or services in close proximity to a consumer using a wireless device.

### BACKGROUND OF THE INVENTION

Methods of locating product or service providers have been conventionally offered by telephone companies and other directory services. As is well known from such “information” services, such services usually require the identity of the product or service provider to already be known, while other types of directories such as “yellow page” directories provide product or service providers by type of product or service provided. Nevertheless, neither information nor yellow page services or directories are able to provide details of product or service providers ranked in relation to a consumer's location.

Furthermore, any such telephonic information and/or yellow page services have conventionally required interaction with an operator to manually locate the information on the product or service provider of interest or on providers of a product or service of interest. Such interactive information services entail the additional expense of staffing operators to provide these information services and is slower in most cases than an automated system. Further, operators are usually unaware of the consumer's location and how to give directions from the consumer's location to a desired product or service provider.

A need exists, therefore, for a provider locating system and method that allows a consumer to obtain information, directions and/or contacts for providers of a desired product or service based on their location. In particular, there is a need for such a system and method configured for use in a wireless networking environment so that the consumer can obtain such a service from any location within the wireless networking environment.

### SUMMARY OF THE INVENTION

In accordance with this invention, a system and method of presenting and selecting product or service provider information via a voice interactive device based upon a consumer's location are provided. A wireless indication of a consumer's location is passed to such a system along with a detailed provider request. The system is then able to locate nearby providers of products or services of interest that match said detailed request. Next, the nearby product or service providers are prioritized according to a predetermined criteria, such as by distance, travel time, sponsorship or other possible criteria. The prioritized listing of nearby providers is then sent to the consumer. The consumer may then select a provider, whereupon the system, in some embodiments, would return detailed information to the consumer on the product or service offered by the provider. In some embodiments, the system may also respond with directions from the consumer's location to the selected provider.

In other embodiments of the present invention, the consumer may have a wireless device capable or receiving digital data representing directions from the consumer's location to a selected provider. Such digital data may be in the form of graphical and/or textual information for depiction by the consumer's wireless device.

In another aspect of the current invention, the system may respond to the consumer's selection of a provider by enabling the consumer to place a telephone call to the selected provider.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a pictorial diagram of a number of devices connected to a wireless network which provides a wireless device with location-based provider information in response to a query in accordance with the present invention;

FIG. 2 is a block diagram illustrating several components of the wireless device shown in FIG. 1 used to request location-based provider information in accordance with the present invention;

FIG. 3 is a block diagram illustrating several of the components of an interactive voice response server shown in FIG. 2 used to communicate with the wireless device using voice signals and to deliver information via a voice signal to the wireless device in accordance with the present invention;

FIG. 4 is a block diagram illustrating several components of a provider server shown in FIG. 2 used to determine what provider information should be provided to the wireless device in accordance with the present invention;

FIG. 5 is a block diagram illustrating several of the components of a mapping server shown in FIG. 2 used to locate a consumer along with locations of providers near to the consumer in accordance with the present invention;

FIG. 6 is a diagram illustrating the actions taken by a wireless device interactive voice response server, provider server, mapping server, and a provider communication device in response to a request in accordance with the present invention;

FIG. 7 is an overview flow diagram illustrating a provision routine implemented by the provider server to identify which provider information should be provided to the wireless device in accordance with the present invention;

FIG. 8 is an overview flow diagram illustrating a prioritization subroutine implemented by the provider server;

FIG. 9 is an overview flow diagram illustrating a location subroutine implemented by the mapping server;

FIG. 10 shows an exemplary wireless device including a screen shot of a graphical representation of directions from a current location to a provider location in accordance with the present invention;

FIG. 11 illustrates an exemplary wireless device with a textual representation of directions from a current location to a provider location in accordance with the present invention.

### DETAILED DESCRIPTION OF THE PREFERRED EMBODIMENT

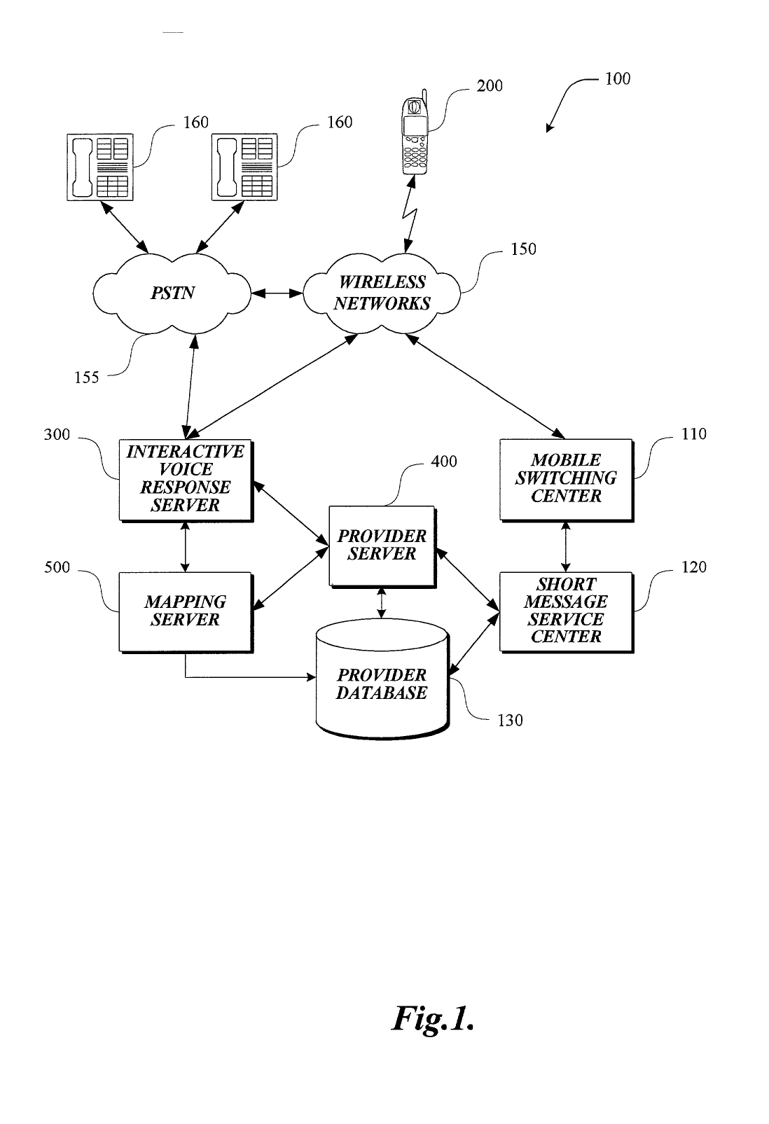

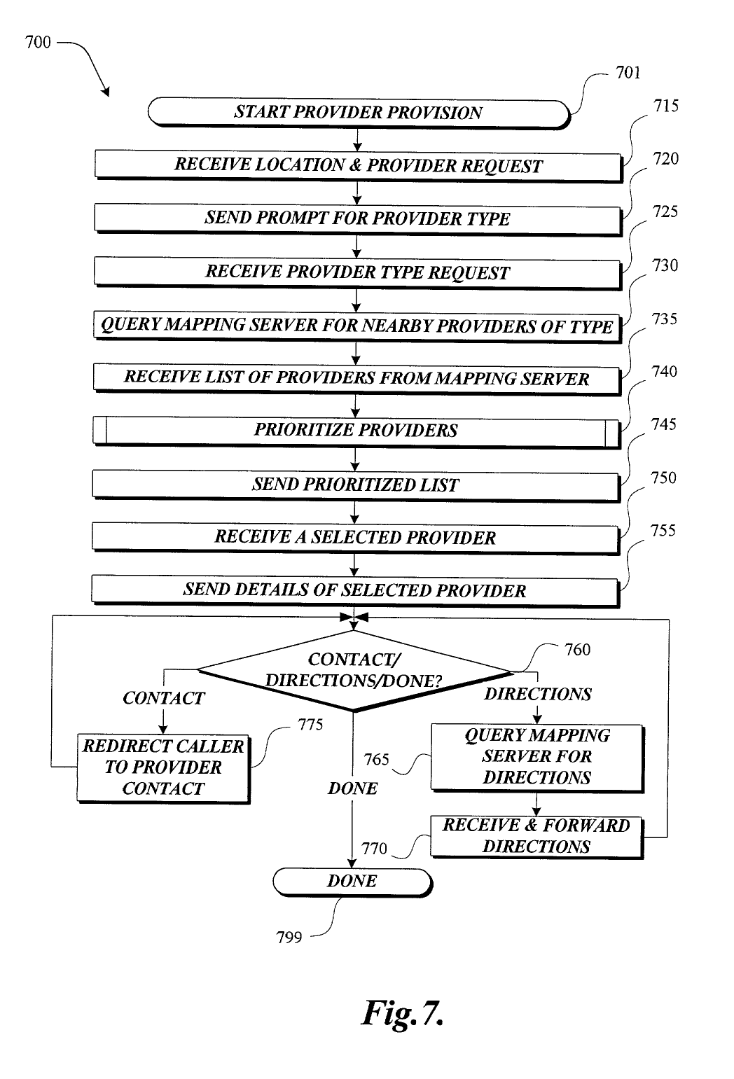

As previously explained, wireless networks may be any form of network in which the communication paths to communication devices are without wires. Many companies are now providing services and access to information and other services over wireless networks. In accordance with the present invention, FIG. 1 illustrates a functional block diagram of a system 100 for locating providers of goods or services (called simply “providers” herein) using such networks. Locating providers is performed by a provision routine, such as provision routine 700, described in greater detail below with regard to FIG. 7.

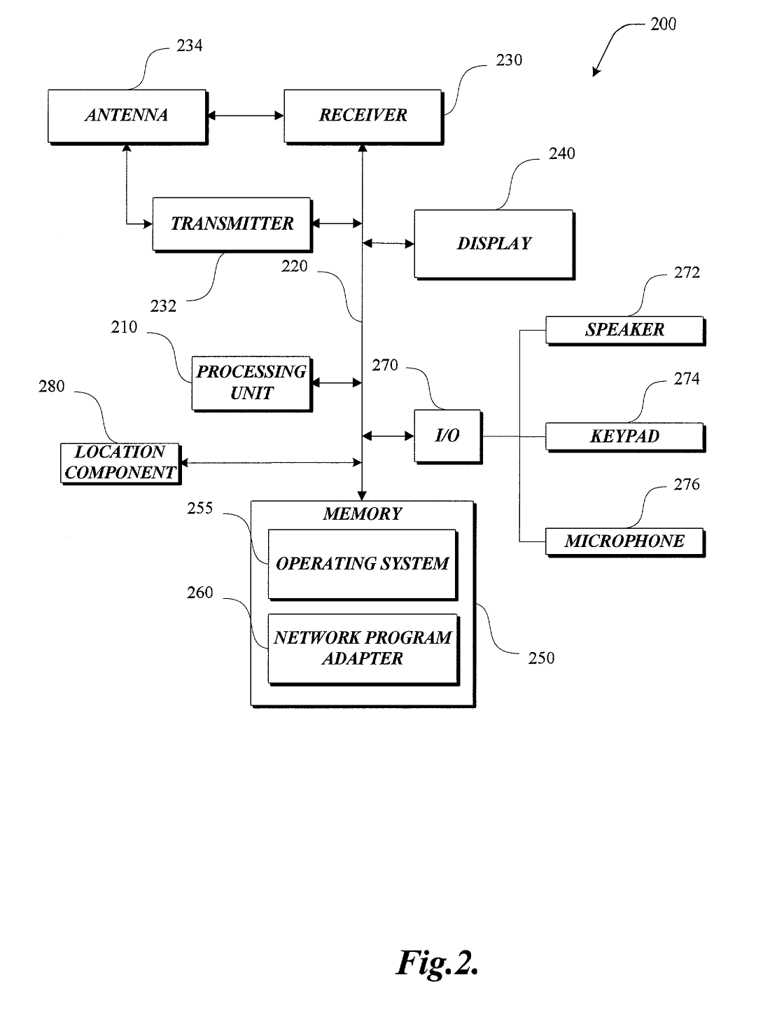

The present invention utilizes a wireless networking environment with one or more interconnected devices to provide a consumer with the locations of nearby providers in response to a request from the consumer. FIG. 1 illustrates a functional block diagram of a system 100 embodying such an environment. The system 100 generally operates in a telecommunications environment comprising conventional telecommunications equipment, including wireless networks as well as individual computing systems interconnected over networks. However, it will be appreciated by those of ordinary skill in the art that the system 100 could equally function as a single stand-alone computer system. In the described embodiment, a voice interactive wireless device 200, an interactive voice response server 300, a provider server 400, a mapping server 500, and a provider database 130 are interconnected over a network. The wireless device 200, the interactive voice response server 300, the provider server 400, and the mapping server 500 are further described below in relation to FIGS. 2, 3, 4 and 5, respectively. The system 100 may also comprise a number of other devices such as a mobile switching center 110, a short message service center 120, a publicly switched telephone network (“PSTN”) 155, and one or more provider communication devices 160. Those of ordinary skill in the art will appreciate that more or less devices may be used in the exemplary system 100. For example, the functionality of the interactive voice response server 300, provider server 400, and the mapping server 500 may all reside on a single computing device. In still another embodiment, multiple interactive voice response servers 300 and/or provider servers 400 may be used in the system 100. Additionally, while only one wireless device 200 has been shown, it will be appreciated that many wireless devices 200 may be used in the system 100.

As shown in FIG. 2, the voice interactive wireless device 200 includes a processing unit 210, a bus 220, a display 240, and a memory 250. The display 240 may include any variety of display devices including, but not limited to, a liquid crystal display, a color display, and/or a light emitting diode display. Also connected to the processor is an input/output interface 270, which connects to a speaker 272, a keypad 274, and a microphone 276. As would be readily understood by one of ordinary skill in the art, alternative input/output configurations are considered to be within the scope of the present invention. The mobile device 200 also includes a receiver 230 and a transmitter 232, which are connected to an antenna 234 for receiving and sending wireless communications, respectively. The mobile device 200 may also include a modulator and demodulator for formatting data transmissions according to an air interface standard. It should be understood that the mobile device 200 may be capable of operating with one or more air interface standards, modulation types and data accessing types without departing from the scope of the invention. The memory 250 generally comprises a random access memory (“RAM”), a read-only memory (“ROM”), and may also include a permanent mass storage device, such as a hard disk drive, tape drive, optical drive, floppy disk drive, CD-ROM, DVD-ROM, or other removable storage drive or device. The memory 250 stores an operating system 255 for controlling operation of the wireless device 200. The memory 250 also includes a network program adapter 260 which may be configured to run programs or receive programs from a network, especially a wireless network with data transmissions in accordance with an air interface standard. The network program adapter 260 may be specifically configured to receive and transmit data from the wireless device 200 such as, but not limited to, wireless markup language (“WML”), wireless application protocol (“WAP”) applications, or other applications sent via various wireless networking or data transmission signals to the wireless device 200. As would be readily understood, the memory 250 may contain additional applications for accessing multiple networks. It will be appreciated that these components may be stored on various computer-readable mediums and loaded into memory using a drive or other communications medium associated with the computer-readable medium, such as the receiver 230. The wireless device 200 may also optionally include a location component 280 such as, but not limited to, a global positioning system device or other component capable of determining a current location of the wireless device 200.

Referring again to FIG. 1, the wireless device 200 is in communication with the wireless networks 150 which include wireless base stations, such as a cellular base station which includes a transceiver and a controller for transmitting and receiving wireless communication data from the wireless device 200. Additionally, the wireless networks 150 may include mobile telephone switching centers, which are known to those skilled in the art as digital telephone exchanges that control switching between base stations and a PSTN 155 for all wireline-to-mobile, mobile-to-wireline, and mobile-to-mobile calls. As will be readily understood by one skilled in the relevant art, the processing of wireless communications may entail additional or alternate components and/or steps. Accordingly, the system disclosed in FIG. 1 is intended solely for illustrative purposes.

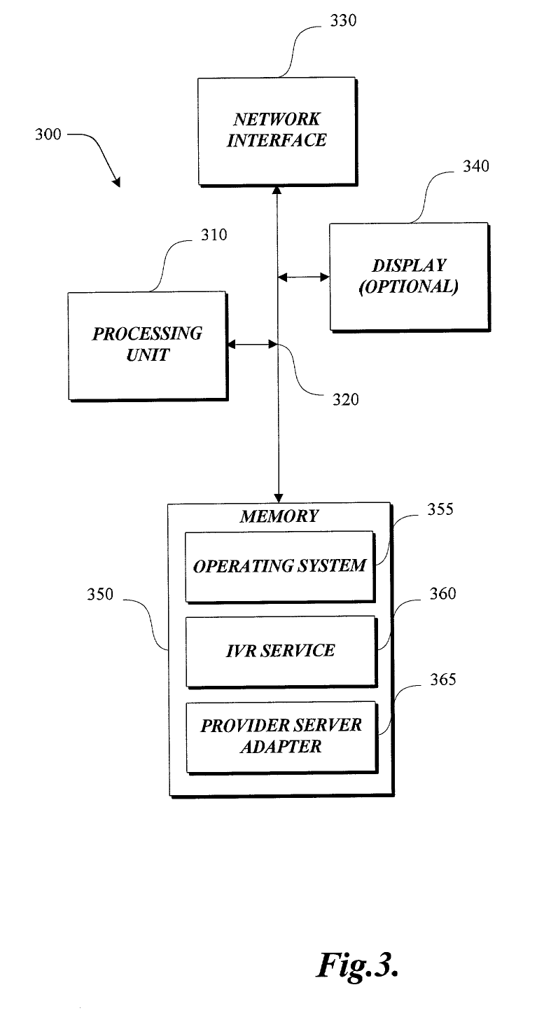

FIG. 3 depicts several of the key components of the interactive voice response server 300. Those of ordinary skill in the art will appreciate that the interactive voice response server 300 includes many more components than those shown in FIG. 3. However, it is not necessary that all of these generally conventional components be shown in order to disclose an enabling embodiment for practicing the present invention. As shown in FIG. 3, the interactive voice response server 300 is connected to the wireless networks 150 via a network interface 330. Those of ordinary skill in the art will appreciate that the network interface 330 includes the necessary circuitry for connecting the interactive voice response server 300 to the wireless networks 150 and for that matter the PSTN 155, and is also constructed for use with the protocols of the particular network configuration of the operating environment in which it is contained.

The interactive voice response server 300 also includes a processing unit 310, an optional display 340, and a memory 350 all interconnected along with the network interface 330 via a bus 320. The memory 350 generally comprises RAM, ROM and one or more permanent mass storage devices, such as a hard disk drive, tape drive, optical drive, floppy disk drive, or combination thereof. The memory 350 stores the program code and data necessary for receiving, processing, formatting and sending voice signals in accordance with the present invention. More specifically, the memory 350 stores an operating system 355 and an interactive voice response (“IVR”) service 360 for providing voice interaction to communication devices such as wireless device 200. Additionally, the memory 350 stores a provider server adapter 365 for interacting with the provider server when converting voice signals to data signals for processing by the voice server and receiving data signals and translating data signals into voice signals for communication with the wireless device 200.

It will be appreciated that the aforementioned software components may be loaded from a computer readable medium into memory 350 of the interactive voice server 300 using a drive mechanism (not shown) associated with the computer-readable medium, such as a floppy, tape, or DVD/CD-ROM drive, or via the network interface 330.

Although an exemplary interactive voice response server 300 has been described that generally conforms to a conventional general purpose computing device, those of ordinary skill in the art will appreciate that an interactive voice response server 300 may be any of a great number of devices capable of communicating via the wireless networks 150.

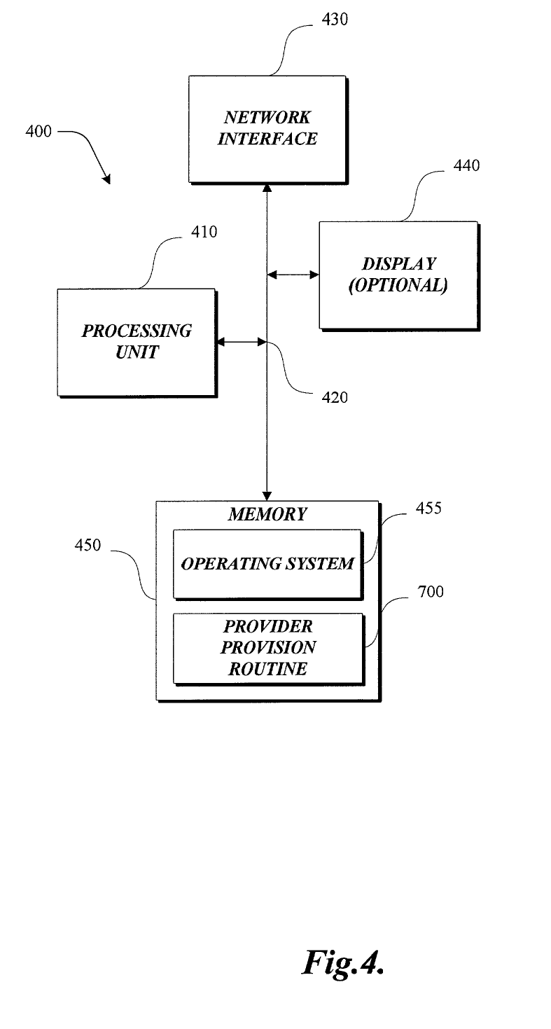

FIG. 4 depicts several of the key components of the provider server 400. Those of ordinary skill in the art will appreciate that the provider server 400 includes many more components than those shown in FIG. 4. However, it is not necessary that all these generally conventional components be shown in order to disclose an enabling embodiment for practicing the present invention. As shown in FIG. 4, the provider server 400 is connected to both the interactive voice response server 300 and the mapping server 500 via a network interface 430. Those of ordinary skill in the art will appreciate that the network interface 430 includes the necessary circuitry for connecting the provider server 400 to the interactive voice response server 300 and mapping server 500, and is also constructed for use with the protocol or protocols of the particular network configuration of the operating environment in which it is contained.

The provider server 400 also includes a processing unit 410, an optional display 440, and a memory 450, all interconnected along with the network interface 430 via a bus 420. The memory 450 generally comprises RAM, ROM and one or more permanent mass storage devices, such as a hard disk drive, tape drive, optical drive, floppy disk drive, or combination thereof. The memory 450 stores the program code and data necessary for receiving, processing and forwarding data, as well as supplying the results of processing in accordance with the present invention. More specifically, the memory 450 stores an operating system 455 and a provision routine 700. The provision routine 700 is used to determine which providers should be sent to a wireless device 200 in response to a provider request in accordance with the present invention. The provision routine 700 is described in greater detail below, with regard to FIG. 7.

It will be appreciated that the aforementioned software components may be loaded from a computer-readable medium into memory 450 of the provider server 400 using a drive mechanism (not shown) associated with the computer-readable medium, such as a floppy, tape or DVD/CD-ROM drive or via the network interface 430. Although an exemplary provider server 400 has been described that generally conforms to a conventional general purpose computing device, those of ordinary skill in the art will appreciate that a provider server 400 may be any of a great number of devices capable of communicating over a network that are also able to process provider information.

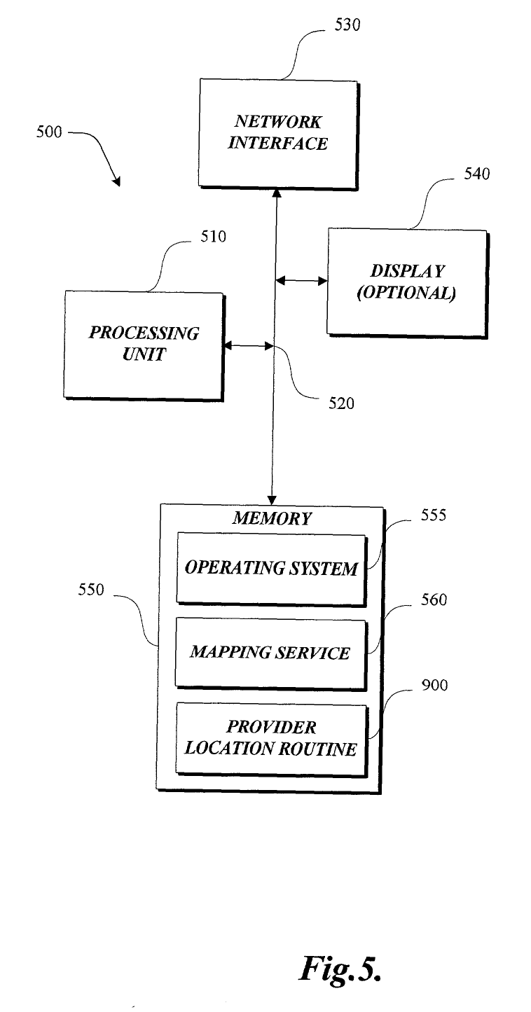

FIG. 5 depicts several of the key components of the mapping server 500. Those of ordinary skill in the art will appreciate that the mapping server 500 includes many more components than those shown in FIG. 5. However, it is not necessary that all of the generally conventional components be shown in order to disclose an enabling embodiment for practicing the present invention. As shown in FIG. 5, the mapping server 500 is connected to other devices via a network interface 530. Those of ordinary skill in the art will appreciate that the network interface 530 includes the necessary circuitry for connecting the mapping server 500 to other devices over a network, and is also constructed for use with the particular network configuration of the operating environment in which it is contained.

The mapping server 500 also includes a processing unit 510, an optional display 540, and a memory 550, all interconnected along with the network interface 530 via a bus 520. The memory 550 generally comprises RAM, ROM and one or more permanent mass storage devices, such as a hard disk drive, tape drive, optical drive, floppy disk drive, or combination thereof. The memory 550 stores the program code and data necessary for locating particular locations or providers and providing directions between a particular location and a particular provider in accordance with the present invention. More specifically, the memory 550 stores an operating system 555, a mapping service 560 and a location routine 900, as shown and described in further detail in FIG. 7 below. Briefly, in response to a provider request, the location routine 900 provides listings of providers matching a request from a consumer using a wireless device 200. It will be appreciated that the aforementioned software components may be loaded from a computer-readable medium into memory 550 of the mapping server 500 using a drive mechanism (not shown) associated with the computer-readable medium such as a floppy, tape or DVD/CD-ROM drive or via the network interface 430.

Although an exemplary travel server 500 has been described that generally conforms to a single conventional general purpose computing device, those of ordinary skill in the art will appreciate the travel server 500 may be a combination of computing devices or components, coordinated to communicate with the provider server 400 and/or the interactive voice response server 300 over a network. Additionally, the mapping service 560 resident in memory 550 of the mapping server 500 may be any form of conventional mapping service able to generate either graphical or textual mapping information or mapping processing, given coordinate locations or other forms of unique location identifiers. It will be appreciated by those of ordinary skill in the art that many forms of mapping service 560 may be suitable for operation in the present invention.

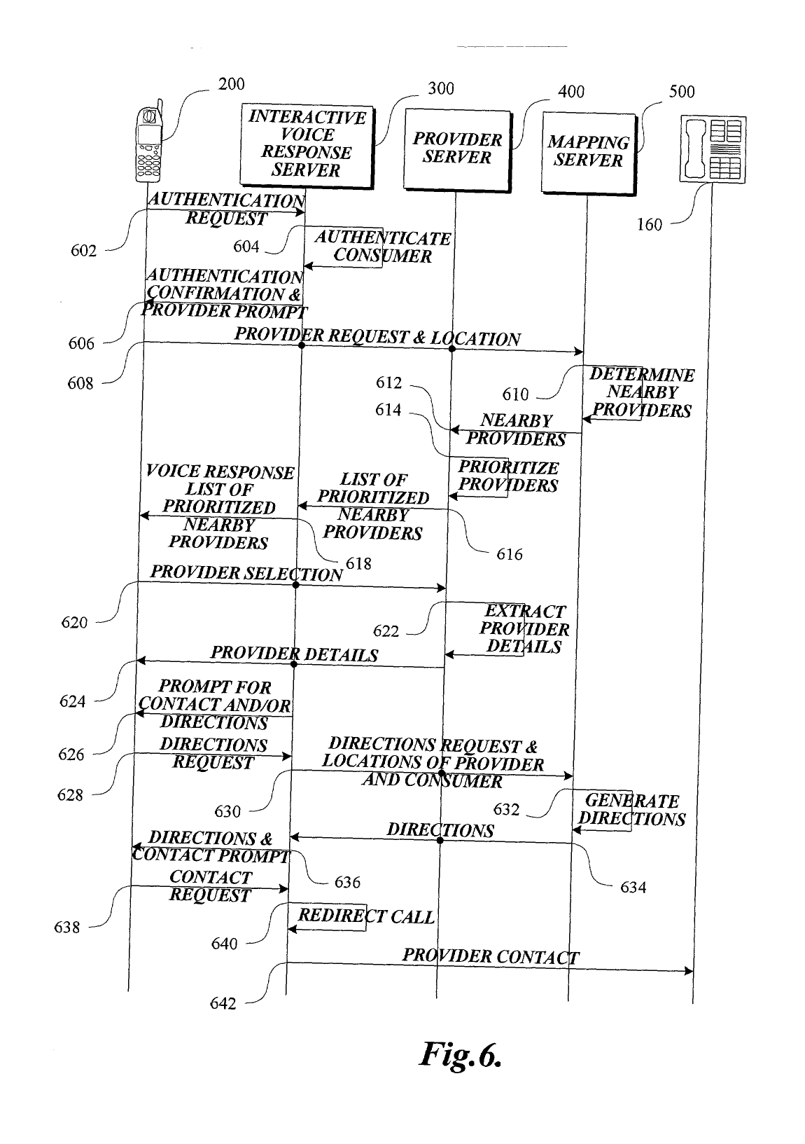

To better illustrate the operation of providing information regarding nearby goods and services and their providers to a consumer, FIG. 6 illustrates one embodiment of interactions between the devices of the location system 100 for identifying nearby providers. While a particular set of messages and devices is used below to describe an illustrative system of identifying providers near a consumer, those of ordinary skill in the art will appreciate that the present invention applies equally well to other types of systems, such as, but not limited to, a system in which the interactive voice response server 300, provider server 400 and mapping server 500 may be combined into two or even a single device. The devices of the system 100 illustrated in FIG. 6 include a wireless device 200, an interactive voice response server 300, a provider server 400, a mapping server 500, and a provider communication device 160. The interactions of, and the routines performed by the various devices are illustrated and described in greater detail with reference to FIGS. 7-9.

Returning to FIG. 6, in some embodiments of the present invention, goods and services and provider identification and location is initiated when a wireless device 200 sends an authentication request 602 to the interactive voice response server 300. Once the interactive voice response server 300 receives the authentication request, it processes the authentication request via its IVR service 360 to authenticate the consumer 604. Authentication of the consumer may be accomplished in numerous ways well known to those of ordinary skill in the art, including biometric methods, such as speaker recognition in a preferred embodiment, as well as by entry of data such as password or PIN number by the consumer. In such embodiments, interactive voice response server 300 then returns an authentication confirmation along with a provider prompt 606 to the wireless device 200. In any case, wireless device 200 then returns a provider request 608 including the current location of the wireless device 200 via the interactive voice response server 300 and the provider server 400 to the mapping server 500.

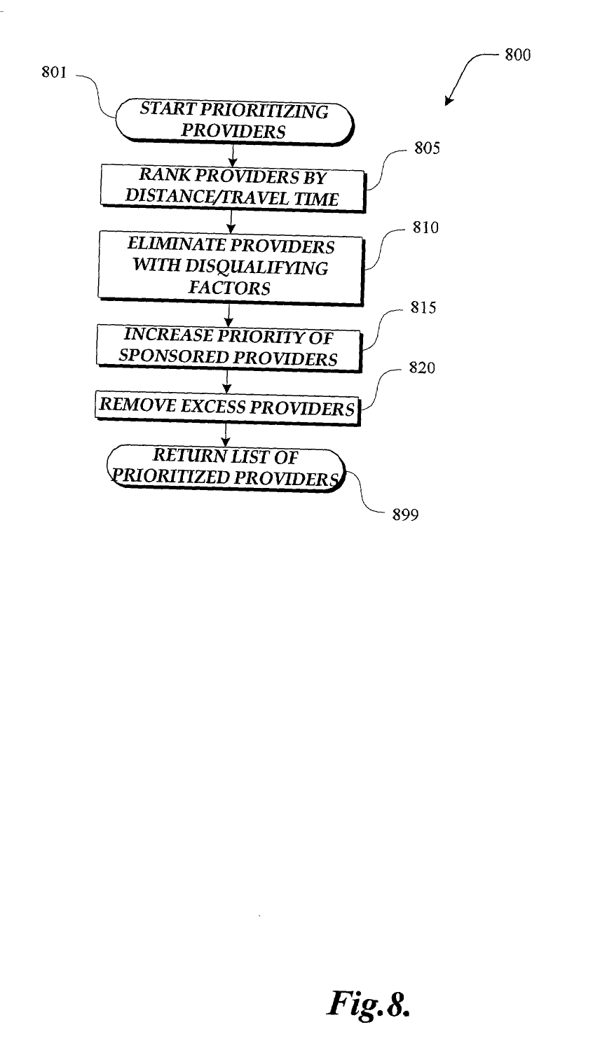

One of ordinary skill in the art will also appreciate that the provider request 608 may include more than a single communication between the wireless device 200 and the interactive voice response server 300. In fact, the provider request 608 may actually be a dialog between the interactive voice response server 300 and the wireless device 200 such that a provider request is incrementally built up until sufficient information has been retrieved to then communicate the provider request 608 including the location to the provider server 400 and the mapping server 500. In any case, once a sufficiently detailed provider request has been received by the mapping server 500, the mapping server 500 is then able to determine nearby providers 610 and then forward a list of nearby providers 612 to the provider server 400. The provider server 400 then prioritizes 614 the providers according to a predetermined order. An exemplary prioritization routine is illustrated in FIG. 8 with regard to prioritization subroutine 800. Next, the provider server 400 forwards a list of prioritized nearby providers 616 to the interactive voice response server 300. The voice response server then forwards a list of prioritized nearby providers in voice format 618 to the wireless communications device 200. The wireless communications device 200 is then able to send a provider selection 620 to the interactive voice response server. The interactive voice response server is then able to extract provider details from a possibly cached list of prioritized nearby providers such as the list of prioritized nearby provider 616 and extract details of the selected provider 622 and then forward the details 624 back to the wireless communications device. The details would include information such as, but not limited to, provider name, address, telephone number, and/or other communication addresses (e.g., e-mail or Web site addresses). The interactive voice response server 300 may then also prompt 626 the wireless communications device for contact and/or direction needs for the selected service provider.

Assuming the consumer wishes to contact a provider in response to the contact prompt 636, they issue a contact request 638 from the wireless device 200 to the interactive voice response server 300. In one embodiment, the interactive voice response server then redirects 640 the call from the wireless device 200 to the interactive voice response server 300. The redirected call is illustrated as a contact 642 via the interactive voice response server 300 to a provider communication device 160, which is associated with the previously selected provider. It will be appreciated by those of ordinary skill in the art that other means of communicating with the provider are possible. For example, the interactive voice response server may not actually redirect the call but may instead instruct the wireless device 200 to initiate a separate call to the provider communication device 160.

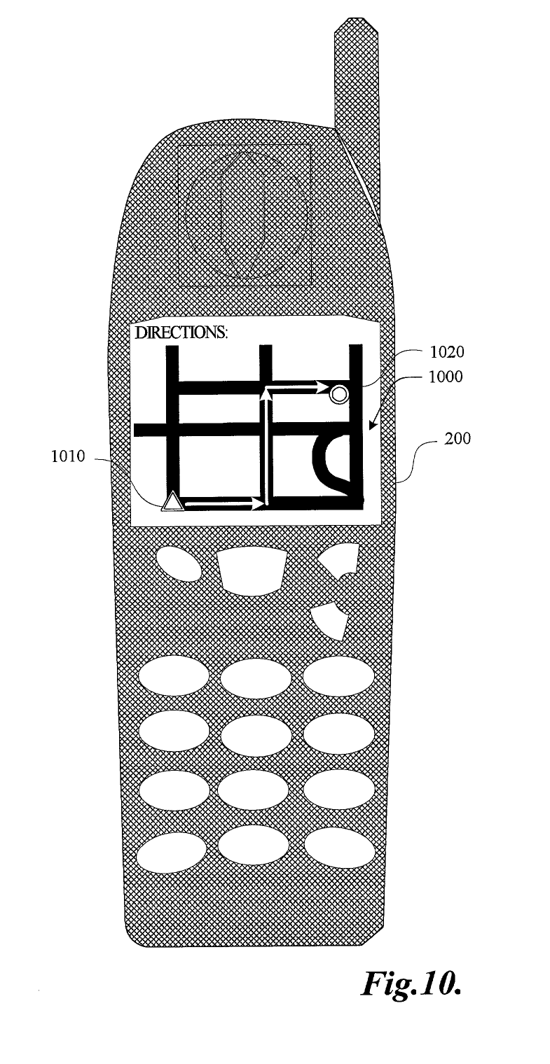

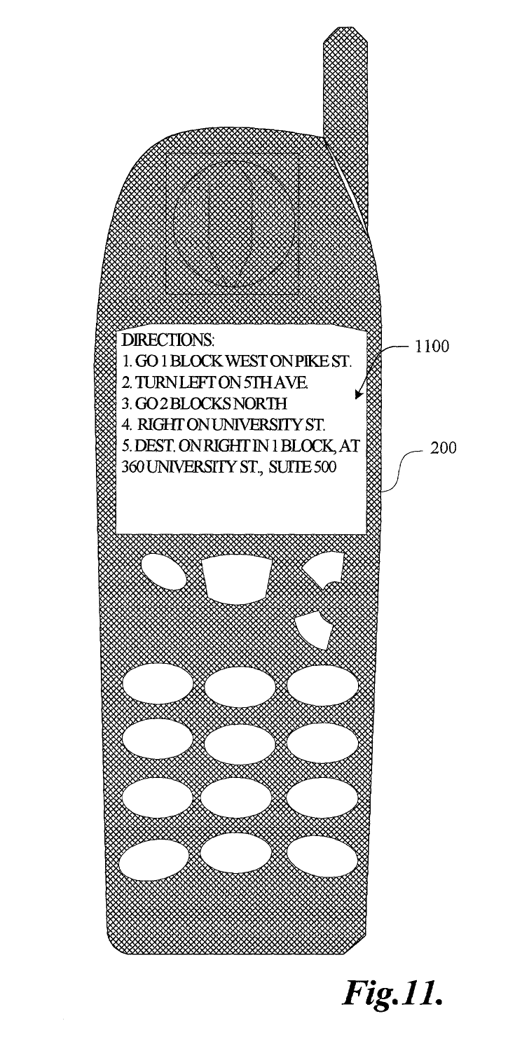

Assuming the consumer using the wireless communication device wishes directions, then a directions request 628 is sent from the wireless communications device 200 to the interactive voice response server. The interactive voice response server 300 then forwards the directions request and locations of the provider and consumer 630 via the provider server 400 to the mapping server 500. The mapping server 500 then generates directions 632, and forwards the directions 634 back through the provider server 400 to the interactive voice response server 300. The directions and possibly a contact prompt 636 are then passed on to the wireless device 200 from the interactive voice response server 300. It will be appreciated by those of ordinary skill in the art that the directions could take a myriad number of forms, such as but not limited to spoken voice directions, graphical map directions (see FIG. 10), textual directions (see FIG. 11), or other forms of conventional directions from a current location to a destination location at a provider.

Note that between the interactions of the various devices in system 100 as illustrated in FIG. 6, the consumer is able to locate the most desirable nearby providers that meet the requirements of their request without having to resort to cumbersome navigational techniques. It will be particularly helpful to understand the benefits of the present invention in light of a following sample dialog:

IVR server: Welcome, what would you like to do?

Consumer: I want to find a restaurant.

IVR server: It appears that you are on the corner of Fifth Avenue and Pike Street. Is this correct?

Consumer: Yes.

IVR server: You selected “restaurant locator”. What type of cuisine?

Consumer: Thai.

IVR server: There are four Thai restaurants in your vicinity: Thai Style—2.2 miles from your current location; Bangkok Cuisine—3.5 miles from your current location (this restaurant is running a promotion, 20% off your first meal if you use an electronic coupon); Siam Square—3.1 miles from your current location; and Thai Bistro—5.6 miles from your current location.

Consumer: I'd like to try the one with the promotion.

IVR server: You have selected Bangkok Cuisine, would you like the electronic coupon?

Consumer: Yes.

IVR server: Would you like to make a reservation or get directions?

Consumer: I would like directions.

IVR server: I have just sent you the directions from your current location. Would you also like to contact the restaurant?

Consumer: Yes, please connect me with the restaurant.

IVR server: Please hold, you are being connected now.

Bangkok Cuisine server provider: Hello, you have reached Bangkok Cuisine.

As seen from the above dialog, which would correspond to the provider request and location 608 and subsequent portions of FIG. 6 as viewed from the consumer's perspective, the present invention enables a consumer to easily locate a desired provider.

As illustrated in FIGS. 1, 4 and 6, the location system 100 of the present invention includes a provider server 400 that is used to identify and provide information regarding providers requested by the wireless device 200. A flow chart illustrating a provision routine 700 implemented by the provider server 400, in accordance with one embodiment of the present invention, is shown in FIG. 7. The provision routine 700 begins in block 701 and proceeds to block 705 where a request and location of a consumer are received from the IVER server 300. Then in block 710, a prompt for a provider type is sent back to the requesting device. In response in block 715 a provider request is received (e.g., restaurant, bank, gas station, etc.). In response to the provider request, the mapping server 500 is queried for nearby providers matching the requested type in block 720. In block 725, a list of nearby providers is received from the mapping server 500. The list of nearby providers is then sent to the prioritization subroutine 800 for prioritization. Once subroutine 800 returns with a list of prioritized nearby providers, the prioritized list is sent to the requesting device in block 730. Then in block 735, an indication of a selected provider is received and the details of the selected provider are then forwarded back to the requesting device in block 740 possibly along with a prompt for either a contact or directions. If there is no request for either a contact or directions, then routine 700 ends at block 799. If, however, in determination block 745 it is determined that directions have been requested, then in block 750 another query is sent to the mapping server 500 for directions from the location to the location of the selected provider. The directions are received from the mapping server in block 755 and are then forwarded on to the requesting device after which routine 700 returns back to determine if further contact or directions are needed at block 745. If, however, at block 745 it is determined that the requesting device would like to contact the selected provider, then in block 765 the requesting device is redirected to the contact communication device of the provider after which routine 700 returns back to determination block 745 to determine if either directions are needed or if processing is done.

The prioritization subroutine 800, introduced above, is illustrated in FIG. 8. The prioritization subroutine 800 is called each time the provision routine needs to prioritize a list of nearby providers. For example, if the providers are to be ranked by actual distance from a location of a wireless device 200, then the providers would be ranked by actual position from the location unless other factors were to alter the actual level of priority. Such other factors might include, but are not limited to, sponsorship of particular providers, consumer preferences, or accessibility issues for a particular provider.

The subroutine 800 starts in block 801 and proceeds to block 805 where the providers are ranked by distance or possibly travel time from a particular location. Next, in block 810, providers with disqualifying factors are eliminated. For example, if a restaurant is on an island which is close to a particular location but is inaccessible unless a boat is available, such a factor might be considered a disqualifying factor when prioritizing the providers. Next in block 815, the priority of sponsored providers is increased above the level in which they would normally fall given their rank by distance and/or travel time. Then, in block 820, excess providers are eliminated if too many providers have been located and the number of providers exceeds a threshold maximum number of providers. Finally in block 899, a prioritized list of providers is returned to the calling routine.

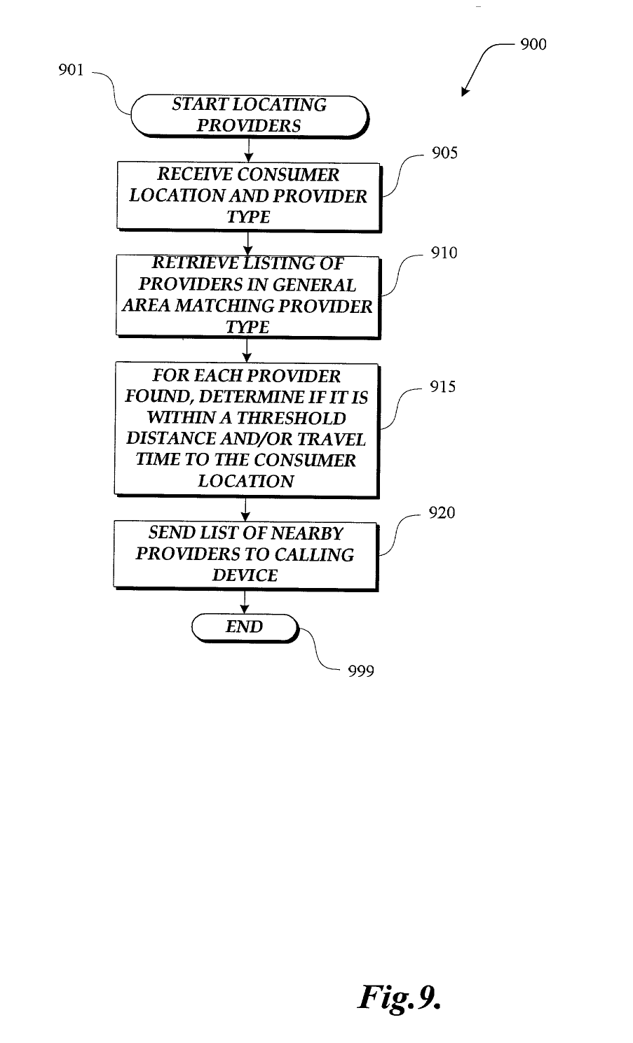

As discussed earlier with regard to directions and actually determining distances and which providers are nearby, the location system 100 includes a mapping server 500 with a location routine 900. FIG. 9 illustrates the location routine 900. Routine 900 starts at block 901 and proceeds to block 905 where a consumer location and provider type are received. Next, in block 910, a listing of providers in the general area matching the indicated type are retrieved from a database, such as provider database 130. Determining that a product or service and/or provider is within a general area is a less specific activity than determining if it is within a threshold distance of a particular location. For example, a simple box may be created around the location by adding or subtracting values from the longitude and latitude coordinates of a location and any providers that fall within the box created by the adding and subtracting a threshold from the coordinates would be considered to be in the general area of the location. Those of ordinary skill in the art will appreciate that other methods may be used to determine if a provider is in the general area of a particular location. In still another example, determining that a provider is in the same metropolitan area would also be sufficient to determine that the provider is in the same general area. Next, in block 915, for each provider found, determine if it was within a threshold distance or, in an alternate embodiment, within a threshold travel time from the consumer location. Next, in block 920, a listing of all providers that fall within the threshold distance and/or travel time from the consumer location are sent back to the device that originally called the location routine. In one embodiment, this is the provider server 400. Routine 900 then ends at block 999.

As discussed above with regard to receiving information, particularly directions, in accordance with the present invention, FIGS. 10 and 11 illustrate two exemplary wireless devices that have received directions in accordance with the present invention. FIG. 10 illustrates a wireless device 200 which has received graphical directions from a current location 1010 to a provider location 1020 which are both displayed on the display 240 of the wireless device 200. On the other hand, FIG. 11 provides a similar exemplary wireless device with textual directions illustrated on its display 240.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. Method of presenting and selecting providers of goods or services via a voice interactive device based upon a consumer's location, the method comprising:
receiving a wireless indication of a consumer's location along with a provider request;
locating nearby providers that match said further details;
prioritizing said nearby providers;
providing a prioritized listing of matching providers nearby to the consumer upon selection of a provider; and
sending details of said provider to the voice interactive device.

2. The method of claim 1, further comprising providing directions to a selected provider.

3. The method of claim 2, wherein said directions comprise a textual description of how to reach said selected provider from said location of the consumer.

4. The method of claim 2, wherein said directions comprise a graphical depiction of how to reach said selected provider from said location of the consumer.

5. The method of claim 2, wherein said directions are delivered via a short message service (SMS) message.

6. The method of claim 2, wherein said directions are delivered via Wireless Applications Protocol (WAP) message.

7. The method of claim 1, further comprising connecting the consumer to a selected provider via the wireless network.

8. The method of claim 7, wherein connecting comprises redirecting the voice interactive device to connect with said selected provider.

9. The method of claim 7, wherein connecting comprises bridging a connection between the voice interactive device and said selected provider.

10. The method of claim 1, wherein said wireless indication of the consumer's location is determined using the wireless network.

11. The method of claim 10, wherein the wireless network is a GSM network.

12. The method of claim 10, wherein the voice interactive device retrieves a present location from system properties resident on the voice interactive device.

13. The method of claim 10, wherein the voice interactive device retrieves a present location from an associated Global Positioning System (GPS) device.

14. The method of claim 13, wherein said GPS device is integrated with said voice interactive device.

15. The method of claim 1, further comprising prompting for further details as a dialog between said voice interactive device and an interactive voice recognition server.

16. The method of claim 1, further comprising authenticating the consumer prior to receiving the consumer's location.

17. The method of claim 16, wherein authenticating further comprises voice identification of the consumer.

18. Computer readable medium containing computer executable instructions for presenting and selecting providers of goods or services via a voice interactive device based upon a consumer's location, comprising:
receiving a wireless indication of a consumer's location along with a provider request;
locating nearby providers that match said further details;
prioritizing said nearby providers;
providing a prioritized listing of matching providers nearby to the consumer upon selection of a provider; and
sending details of said provider to the consumer.

19. The computer readable medium of claim 18, further comprising computer executable instructions for providing directions to a selected provider.

20. The computer readable medium of claim 19, wherein said directions comprise a textual description of how to reach said selected provider from said location of the consumer.

21. The computer readable medium of claim 19, wherein said directions comprise a graphical depiction of how to reach said selected provider from said location of the consumer.

22. The computer readable medium of claim 19, wherein said directions are delivered via a short message service (SMS) message.

23. The computer readable medium of claim 19, wherein said directions are delivered via Wireless Applications Protocol (WAP) message.

24. The computer readable medium of claim 18, further comprising computer executable instructions for connecting the consumer to a selected provider via the wireless network.

25. The computer readable medium of claim 24, wherein connecting comprises redirecting the voice interactive device to connect with said selected provider.

26. The computer readable medium of claim 24, wherein connecting comprises bridging a connection between the voice interactive device and said selected provider.

27. The computer readable medium of claim 18, wherein said wireless indication of the consumer's location is determined using the wireless network.

28. The computer readable medium of claim 27, wherein the wireless network is a GSM network.

29. The computer readable medium of claim 27, wherein the voice interactive device retrieves a present location from system properties resident on the voice interactive device.

30. The computer readable medium of claim 27, wherein the voice interactive device retrieves a present location from an associated Global Positioning System (GPS) device.

31. The computer readable medium of claim 30, wherein said GPS device is integrated with said voice interactive device.

32. The computer readable medium of claim 18, wherein prompting for further details proceeds as a dialog between said voice interactive device and an interactive voice recognition server.

33. The computer readable medium of claim 18, further comprising computer executable instructions for authenticating the consumer prior to receiving the consumer's location.

34. The computer readable medium of claim 33, wherein authenticating further comprises voice identification of the consumer.

35. System for presenting and selecting providers of goods or services via a voice interactive device based upon a consumer's location, the system comprising:
an interactive voice response server operative to:
receive a wireless indication of a consumer's location along with a provider request; and
forward said location and said provider request to a mapping server;
the mapping server operative to:
locate nearby providers that match said further details; and
forward a list of said nearby providers to a service server; and
the service server operative to:
prioritize said nearby providers;
provide a prioritized listing of matching providers nearby to the consumer in cooperation with said interactive voice response server; and
upon selection of a provider by said consumer, send details of said provider to the consumer in cooperation with said interactive voice response server.

36. The system of claim 35, further wherein said mapping server is further operative to forward directions to a selected provider.

37. The system of claim 36, wherein said directions comprise a text description of how to reach said selected provider from said location of the consumer.

38. The system of claim 36, wherein said directions comprise a graphical depiction of how to reach said selected provider from said location of the consumer.

39. The system of claim 36, wherein said directions are delivered via a short message service (SMS) message.

40. The system of claim 36, wherein said directions are delivered via Wireless Applications Protocol (WAP) message.

41. The system of claim 35, wherein said interactive voice response server is further operative to connect the consumer to a selected provider via the wireless network.

42. The system of claim 41, wherein connecting comprises redirecting the voice interactive device to connect with said selected provider.

43. The system of claim 41, wherein connecting comprises bridging a connection between the voice interactive device and said selected provider.

44. The system of claim 35, wherein said wireless indication of the consumer's location is determined using the wireless network.

45. The system of claim 44, wherein the wireless network is a GSM network.

46. The system of claim 44, wherein the voice interactive device is operative to retrieve and forward a present location from system properties resident on the voice interactive device.

47. The system of claim 44, wherein the voice interactive device is operative to retrieve a present location from an associated Global Positioning System (GPS) device.

48. The system of claim 47, wherein said GPS device is integrated with the voice interactive device.

49. The system of claim 35, wherein said interactive voice response server is operative to prompt for further details of a provider request in a dialog fashion with the voice interactive device.

50. The system of claim 35, wherein said interactive voice response server is further operative to authenticate the consumer prior to receiving the consumer's location.

51. The system of claim 50, wherein authenticating further comprises voice identification of the consumer.

52. Apparatus for presenting and selecting providers of goods or services via a voice interactive device based upon a consumer's location, the apparatus operative to:
receive a wireless indication of a consumer's location along with a provider request;
locate nearby providers that match said further details;
prioritize said nearby providers;
provide a prioritized listing of matching providers nearby to the consumer; and
upon selection of a provider by said consumer, send details of said provider to the consumer.
